(19) United States
(12) Patent Application Publication
(10) Pub. No.: US 2013/0185516 A1
(43) Pub. Date: Jul. 18, 2013

(54) Use of Loop and Addressing Mode Instruction Set Semantics to Direct Hardware Prefetching

(71) Applicants: Peter G. Sassone, Austin, TX (US); Suman Mamidi, Austin, TX (US); Elizabeth Abraham, Austin, TX (US); Suresh K. Venkumahanti, Austin, TX (US); Lucian Codrescu, Austin, TX (US)

(72) Inventors: Peter G. Sassone, Austin, TX (US); Suman Mamidi, Austin, TX (US); Elizabeth Abraham, Austin, TX (US); Suresh K. Venkumahanti, Austin, TX (US); Lucian Codrescu, Austin, TX (US)

(73) Assignee: QUALCOMM Incorporated, San Diego, CA (US)

(21) Appl. No.: 13/350,914

(22) Filed: Jan. 16, 2012

(51) Int. Cl. G06F 12/12

(52) U.S. Cl. 711/137; 711/E12.004

(57) ABSTRACT

Systems and methods for prefetching cache lines into a cache coupled to a processor. A hardware prefetcher is configured to recognize a memory access instruction as an auto-increment-address (AIA) memory access instruction, infer a stride value from an increment field of the AIA instruction, and prefetch lines into the cache based on the stride value. Additionally or alternatively, the hardware prefetcher is configured to recognize that prefetched cache lines are part of a hardware loop, determine a maximum loop count of the hardware loop, and a remaining loop count as a difference between the maximum loop count and a number of loop iterations that have been completed, select a number of cache lines to prefetch, and truncate an actual number of cache lines to prefetch to be less than or equal to the remaining loop count, when the remaining loop count is less than the selected number of cache lines.

### REFERENCE CO-PENDING APPLICATIONS FOR PATENT

The present application for patent is related to the following co-pending U.S. patent application Ser. No.: “UTILIZING NEGATIVE FEEDBACK FROM UNEXPECTED MISS ADDRESSES IN A HARDWARE PREFETCHER” by Peter Sassone et al., having Attorney Docket No. 111452, filed concurrently herewith, assigned to the assignee hereof, and expressly incorporated by reference herein.

### FIELD OF DISCLOSURE

Disclosed embodiments relate to hardware prefetching for populating caches. More particularly, exemplary embodiments are directed to hardware loops and auto/post—increment-address memory access instructions configured for low-latency energy-efficient hardware prefetching.

### BACKGROUND

Cache mechanisms are employed in modern processors to reduce latency of memory accesses. Caches are conventionally small in size and located close to processors to enable faster access to information such as data/instructions, thus avoiding long access paths to main memory. Populating the caches efficiently is a well recognized challenge in the art. Theoretically, the caches will contain information that is most likely to be used by the corresponding processor. One way to achieve this is by storing recently accessed information under the assumption that the same information will be needed again by the processor. Complex cache population mechanisms may involve algorithms for predicting future accesses, and storing the related information in the cache.

Hardware prefetchers are known in the art for populating caches with prefetched information, i.e. information fetched in advance of the time such information is actually requested by programs or applications running in the processor coupled to the cache. Prefetchers may employ algorithms for speculative prefetching based on memory addresses of access requests or patterns of memory accesses.

Prefetchers may base prefetching on memory addresses or program counter (PC) values corresponding to memory access requests. For example, prefetchers may observe a sequence of cache misses and determine a pattern such as a stride. A stride may be determined based on a difference between addresses for the cache misses. For example, in the case where consecutive cache miss addresses are separated by a constant value, the constant value may be determined to be the stride. If a stride is established, a speculative prefetch may be performed based on the stride and the previously fetched value for a cache miss. Prefetchers may also specify a degree, i.e. a number of prefetches to issue based on a stride, for every cache miss.

While prefetchers may reduce memory access latency if the prefetched information is accurate and timely, implementing the associated speculation is expensive in terms of resources and energy. Moreover, incorrect predictions and prefetches prove to be very detrimental to the efficiency of the processor. Due to limited cache size, incorrect prefetches may also replace correctly populated information in the cache. Conventional prefetchers may include complex algorithms to learn, evaluate, and relearn the patterns such as stride values to determine and improve accuracy of prefetches.

Some hardware prefetchers may be augmented with software hints to provide the prefetcher with additional guidance in what and when to prefetch, in order to improve accuracy and usefulness of prefetched information. However, implementing useful and meaningful software hints requires programmer intervention for particular programs/applications running in the corresponding processor. Such customized programmer intervention is not scalable or extendable to other programs/applications. Moreover the lack of automation which may be inherent to programmer intervention is also time consuming and expensive.

Accordingly, there is a need in the art to improve accuracy and efficiency of hardware prefetchers while avoiding aforementioned drawbacks associated with conventional hardware prefetchers.

### SUMMARY

Exemplary embodiments of the invention are directed to systems and methods for populating a cache using a hardware prefetcher.

For example, an exemplary embodiment is directed to a method of populating a cache comprising; recognizing a memory access instruction as an auto-increment-address memory access instruction; inferring a stride value from an increment field of the auto-increment-address memory access instruction; and prefetching lines into the cache based on the stride value.

Another exemplary embodiment is directed to a method of populating a cache comprising: initiating a prefetch operation; recognizing that prefetched cache lines are part of a hardware loop; determining a maximum loop count as a loop count specified in the hardware loop; determining a remaining loop count as a difference between the maximum loop count and a number of loop iterations that have been completed; selecting a number of cache lines to prefetch into the cache; and truncating an actual number of cache lines to prefetch to be less than or equal to the remaining loop count, when the remaining loop count is less than the selected number of cache lines.

Another exemplary embodiment is directed to a hardware prefetcher comprising: logic configured to receive instructions; logic configured to recognize an instruction an auto-increment-address memory access instruction; logic configured to infer a stride value from an increment field of the auto-increment-address memory access instruction; and logic configured to prefetch lines into a cache coupled to the hardware prefetcher based on the stride value.

Another exemplary embodiment is directed to a hardware prefetcher for prefetching cache lines into a cache comprising: logic configured to receive instructions; logic configured to recognize that instructions received are part of a hardware loop; logic configured to determine a maximum loop count as a loop count specified in the hardware loop; logic configured to determine a remaining loop count as a difference between the maximum loop count and a number of loop iterations that have been completed; logic configured to select a number of cache lines to prefetch into the cache; and logic configured to truncate an actual number of cache lines to prefetch to be less than or equal to the remaining loop count, when the remaining loop count is less than the selected number of cache lines.

Another exemplary embodiment is directed to a processing system comprising: a cache;

a memory; means for recognizing an instruction for accessing the memory as an auto-increment-address memory access instruction; means for inferring a stride value from an increment field of the auto-increment-address memory access instruction; and means for prefetching lines into the cache based on the stride value.

Another exemplary embodiment is directed to a processing system comprising: a cache; means for initiating a prefetch operation for prefetching cache lines into the cache; means for recognizing that prefetched cache lines are part of a hardware loop; means for determining a maximum loop count as a loop count specified in the hardware loop; means for determining a remaining loop count as a difference between the maximum loop count and a number of loop iterations that have been completed; means for selecting a number of cache lines to prefetch; and means for truncating an actual number of cache lines to prefetch to be less than or equal to the remaining loop count, when the remaining loop count is less than the selected number of cache lines.

Another exemplary embodiment is directed to a non-transitory computer-readable storage medium comprising code, which, when executed by a processor, causes the processor to perform operations for prefetching cache lines from a memory into a cache coupled to the processor, the non-transitory computer-readable storage medium comprising: code for recognizing an instruction for accessing the memory as an auto-increment-address memory access instruction; code for inferring a stride value from an increment field of the auto-increment-address memory access instruction; and code for prefetching lines into the cache based on the stride value.

Another exemplary embodiment is directed to a non-transitory computer-readable storage medium comprising code, which, when executed by a processor, causes the processor to perform operations for prefetching cache lines from a memory into a cache coupled to the processor, the non-transitory computer-readable storage medium comprising: code for initiating a prefetch operation for prefetching cache lines into the cache; code for recognizing that prefetched cache lines are part of a hardware loop; code for determining a maximum loop count as a loop count specified in the hardware loop; code for determining a remaining loop count as a difference between the maximum loop count and a number of loop iterations that have been completed; code for selecting a number of cache lines to prefetch; and code for truncating an actual number of cache lines to prefetch to be less than or equal to the remaining loop count, when the remaining loop count is less than the selected number of cache lines.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a schematic representation of a processing system 100 including a hardware prefetcher configured according to exemplary embodiments.

FIG. 2 illustrates a flow diagram for implementing a method of populating a cache with prefetch operations corresponding to a hardware loop, according to exemplary embodiments.

FIG. 3 illustrates a flow diagram for implementing a method of populating a cache with prefetch operations corresponding to an auto-increment-address instruction, according to exemplary embodiments.

FIG. 4 illustrates an exemplary wireless communication system 400 in which an embodiment of the disclosure may be advantageously employed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of Which have been contemplated to be within the scope of the claimed subject matter. In addition, for each of the embodiments described herein, the corresponding form of any such embodiments may be described herein as, for example, “logic configured to” perform the described action.

Exemplary embodiments relate to instructions configured to improve accuracy and efficiency of hardware prefetchers. For example, exemplary instructions may provide hints for hardware prefetchers with regard to hardware loops. Exemplary instructions may include semantics configured to provide confidence information for prefetchers. The semantics may include combinations of information pertaining to the number of iterations or a loop count accompanying start and end address values, etc for hardware loops. Exemplary hardware prefetchers may effectively utilize the semantics to quickly recognize and correctly lock down patterns for prefetching, such as the stride value.

Other exemplary instructions may include a post-increment-address or an auto-increment-address mode. Exemplary embodiments of hardware prefetchers may be configured to recognize instructions in the auto-increment-address format, and glean a stride value from the instructions. Thus, embodiments may extract parameters such as a stride value in an efficient manner from the instructions without having to traverse a sequence of steps to learn and develop confidence in speculative stride values. Additionally or alternatively, embodiments may also be configured to determine that the instruction may be part of a hardware loop, determine a loop count of the hardware loop and truncate the number of cache lines to prefetch, when a remaining loop count is less than a number of cache lines to prefetch based on the loop count.

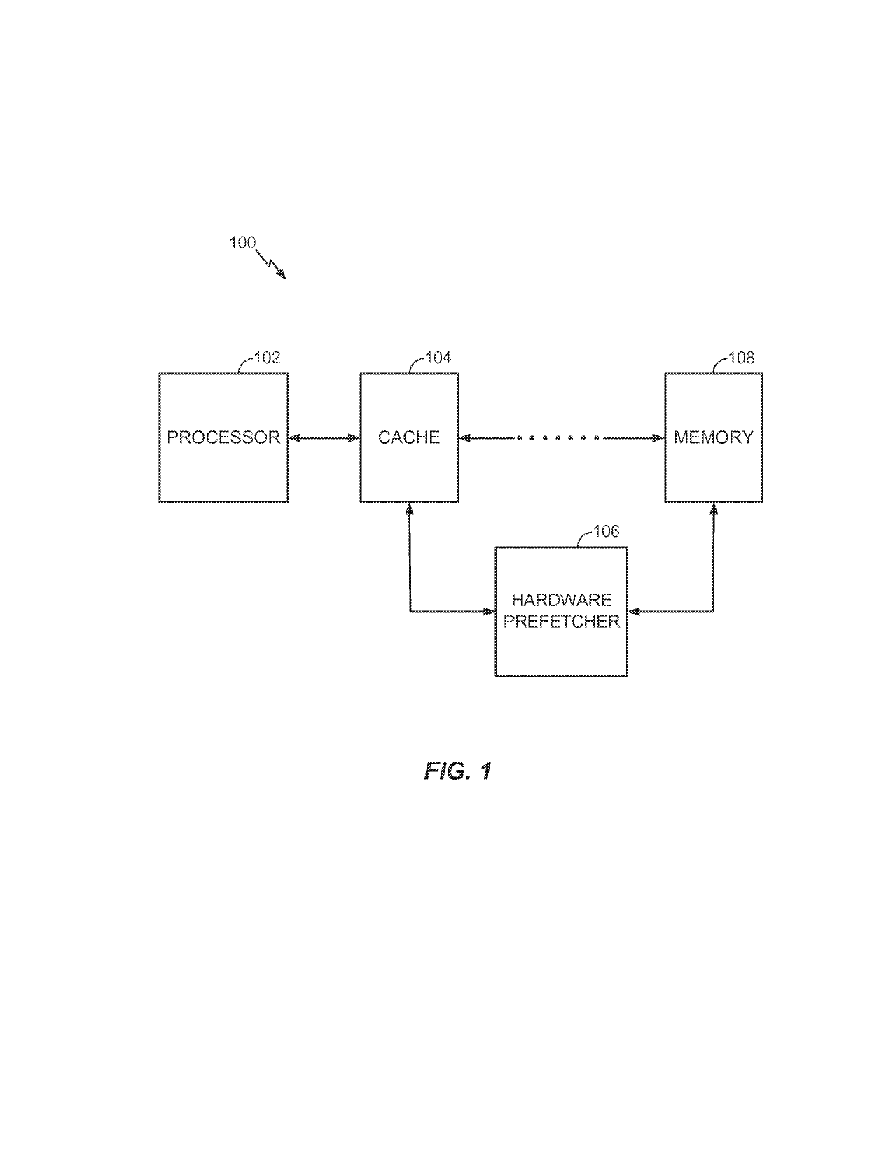

With reference now to FIG. 1, a schematic representation of a processing system 100 including hardware prefetcher 106 configured according to exemplary embodiments is illustrated. As shown, processor 102 may be operatively coupled to cache 104. Cache 104 may be in communication with a memory such as memory 108. While not illustrated, one or more levels of memory hierarchy between cache 104 and memory 108 may be included in processing system 100. Hardware prefetcher 106 may be in communication with cache 104 and memory 108, such that cache 104 may be populated with pre etched information from memory 108 according to exemplary embodiments. The schematic representation of processing system 100 shall not be construed as limited to the illustrated configuration. One of ordinary skill will recognize suitable techniques for implementing the algorithms described with regard to exemplary hardware prefetchers in any other processing environment without departing from the scope of the exemplary embodiments described herein.

In one embodiment, processor 102 may be configured to execute an exemplary instruction set architecture (ISA) which may include specific instructions for hardware loops. A hardware loop instruction may specify fields such as start address and end address or loop count. For example, a hardware loop instruction may be of the format: loop0 (start=start_address, count=10). Processor 102 may be configured to execute loop0 by fetching one or more instructions and/or data from the specified address, start_address, and executing them for the specified number of times defined by count=10.

Hardware prefetcher 106 may be configured to recognize the exemplar instruction ins loop0 as a hardware loop. Once loop0 is encountered during the execution of programs or applications in processor 102, hardware prefetcher 106 may begin to prefetch information related to instructions/data for executing subsequent iterations of loop0 into cache 104. By recognizing loop0 hardware prefetcher 106 need not analyze the instruction further for determining patterns such as stride value and degree, but may prefetch information pertaining to loop0 with a high level of confidence. Hardware prefetcher 106 may designate the count value specified in loop0 as the maximum loop count. Hardware prefetcher 106 may then determine a remaining loop count from the maximum loop count and the number of loop iterations already completed. In other words, the remaining loop count may be determined as the difference between the maximum loop count and the number of loop iterations that have been completed.

This remaining loop count value may be used as an upper bound for selecting the number of prefetches to issue. In some embodiments, hardware prefetcher 106 may be configured to issue prefetches for only the data pertaining to a small number of loop iterations beyond the number of loop iterations that have been completed, while ensuring that the number of cache lines to prefetch does not go past the established upper bound. Thus, hardware prefetcher 106 may be prevented from prefetching unwanted information beyond the expected termination of loop0. In other words, if at any point in the prefetching operations, hardware prefetcher 106 is about to issue a selected number of prefetches, but determines that the remaining loop count is less than the selected number of prefetches, then hardware prefetcher may truncate the actual number of prefetches it issues to be less than or equal to the remaining loop count.

Following a numerical example, once hardware prefetcher 106 initiates a prefetch operation into cache 104 and recognizes that the prefetched cache lines (information) are part of loop0, hardware prefetcher 106 may determine the maximum loop count of loop0 as 10. Assuming 4 loop iterations have already been completed, hardware prefetcher 106 may determine the remaining loop count as the difference between the maximum loop count, 10 and the number of loop iterations that have been completed, 4, i.e. the remaining loop count is 6. Hardware prefetcher 106 may then select a number of prefetches to issue as any number which is less than the remaining loop count, 6. For example, this selected number of prefetches may be 4. Once the selected number of prefetches have been issued, the number of loop iterations that have completed may be assumed to be 8 for purposes of this example, because information pertaining to 4 more loop iterations will already be in the cache. Hardware prefetcher may once again try to issue 4 more prefetches, hut will recognize that the remaining loop count at that stage is 2 (i.e. maximum loop count 10−number of loop iterations completed, 8). However, now the remaining loop count, 2 is less than the selected number of prefetches, 4. Therefore hardware prefetcher 106 will truncate the actual number of prefetches it will issue to be less than or equal to the remaining loop count. Accordingly, hardware prefetcher 106 may truncate the actual number of prefetches it issues to 1 or 2, down from the selected number of prefetches, 4.

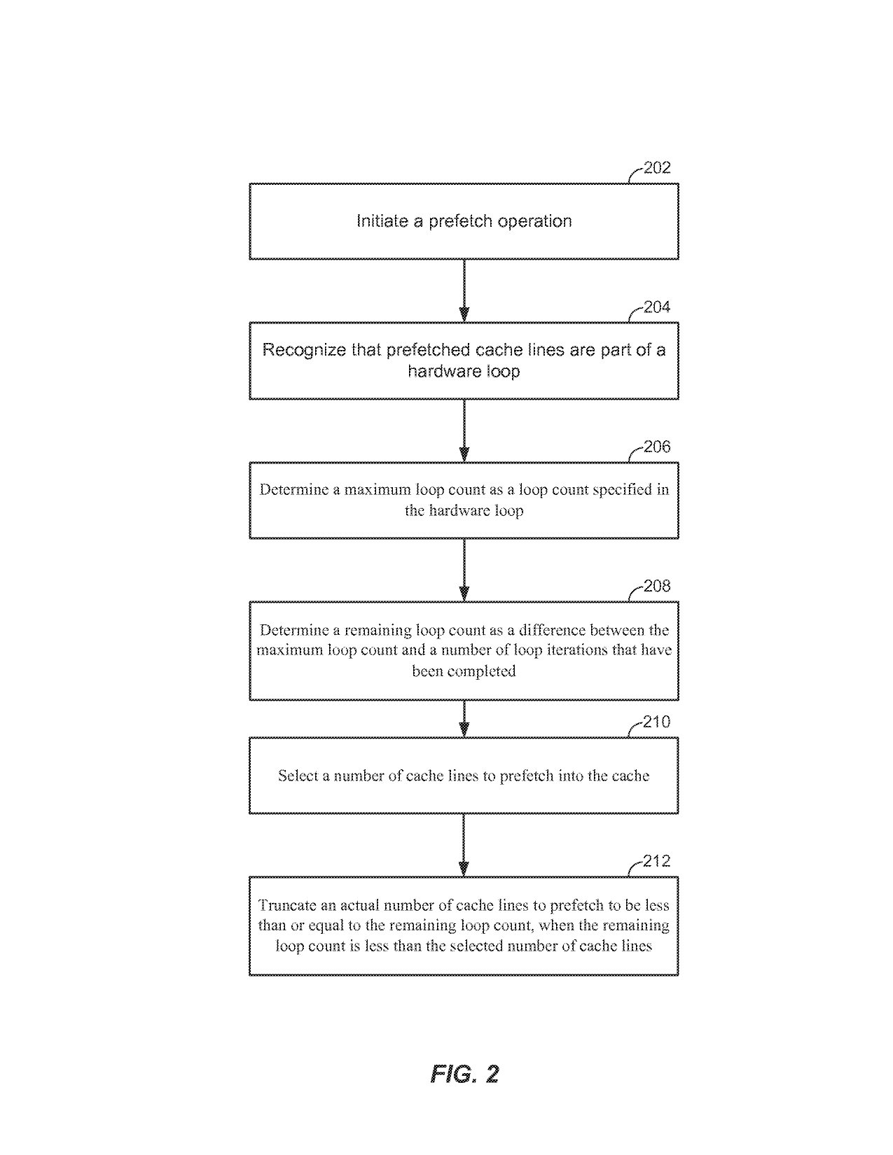

It will be appreciated that embodiments include various methods for performing the processes, functions and/or algorithms disclosed herein. For example, as illustrated in FIG. 2, an embodiment can include a method of populating a cache (e.g. populating cache 104 by hardware prefetcher 106) comprising: initiating a prefetch operation—Block 202; recognizing that prefetched cache lines are part of a hardware loop (e.g. loop0)—Block 204; determining a maximum loop count as a loop count specified in the hardware loop (e.g. count=10)—Block 206; c—Block 208; selecting a number of cache lines to prefetch into the cache—Block 210; and truncating an actual number of cache lines to prefetch to be less than or equal to the remaining loop count, when the remaining loop count is less than the selected number of cache lines—Block 212.

In another exemplary embodiment, hardware prefetcher 106 may be configured to derive parameters such as a stride value, directly from specified instructions, instead of studying cache miss address patterns. Such specified instructions may include an auto-increment—address (also known as a post—increment-address) memory access instruction. An auto-increment-address instruction may update the base-address of a memory access after the associated memory access (load/store) of the instruction is performed. Processor 102 may be configured to execute an exemplary instruction set architecture (ISA) which may include auto-increment-address instructions. An exemplary auto-increment-address instruction may be of the format: r2=load (r1++0x10). When this instruction is executed by processor 102, the semantics of this exemplary instruction can be represented as: (1) performing a load from address r1 in memory 101 to register r2 in processor 102; and (2) increment the address r1 by 0x10.

Accordingly, hardware prefetcher 106 may recognize an auto-increment-address instruction as above, and enter into an auto-increment-address mode. In this mode, hardware prefetcher 106 may determine that the auto-increment-address may be part of a well defined hardware loop. Consequently, hardware prefetcher may avoid the process of trying to determine memory access patterns, such as a stride value, because the value of the increment field (i.e. “0x10” in the instruction r2=load (r1++0x10)) may be determined as the stride value. Because this determination of the stride value can be made with a high level of confidence, prefetching may commence with this stride value and may begin directly after the auto-increment-address is recognized, thus avoiding the delay caused by traversing a sequence of addresses to determine a stride value.

Moreover, aspects of the previously described embodiment with regard to loop0 may be implemented in the auto-increment-address mode. For example, the exemplary auto-increment-address instruction may be part of a hardware loop. In such cases, the stride value may be determined as the increment field as above. Further, hardware prefetcher 106 may determine the number of cache lines to prefetch into cache 104, based on a comparison of the remaining loop count of the hardware loop and the stride value. As previously, the remaining loop count may be determined as a difference between the maximum loop count (which is specified in the hardware loop, loop0, as the count value) and the number of loop iterations which have been completed. The remaining loop count may be used as an upper bound for selecting the number of cache lines to prefetch. Once again, the actual number of cache lines that will be prefetched may be truncated when the value of the remaining loop count is less than the selected number of cache lines to prefetch.

It will be recognized that while description is provided with respect to a load instruction in the auto-increment-address mode, embodiments may be equally applicable and easily extended to store instructions. Further, by preventing prefetch operations to go beyond the end of the loop for hardware loops, and by efficiently recognizing stride values in auto-increment-address mode, hardware prefetcher 106 may improve accuracy and latency of prefetching in well defined loops as well as load/store memory accesses represented in the format of auto-increment-address instructions.

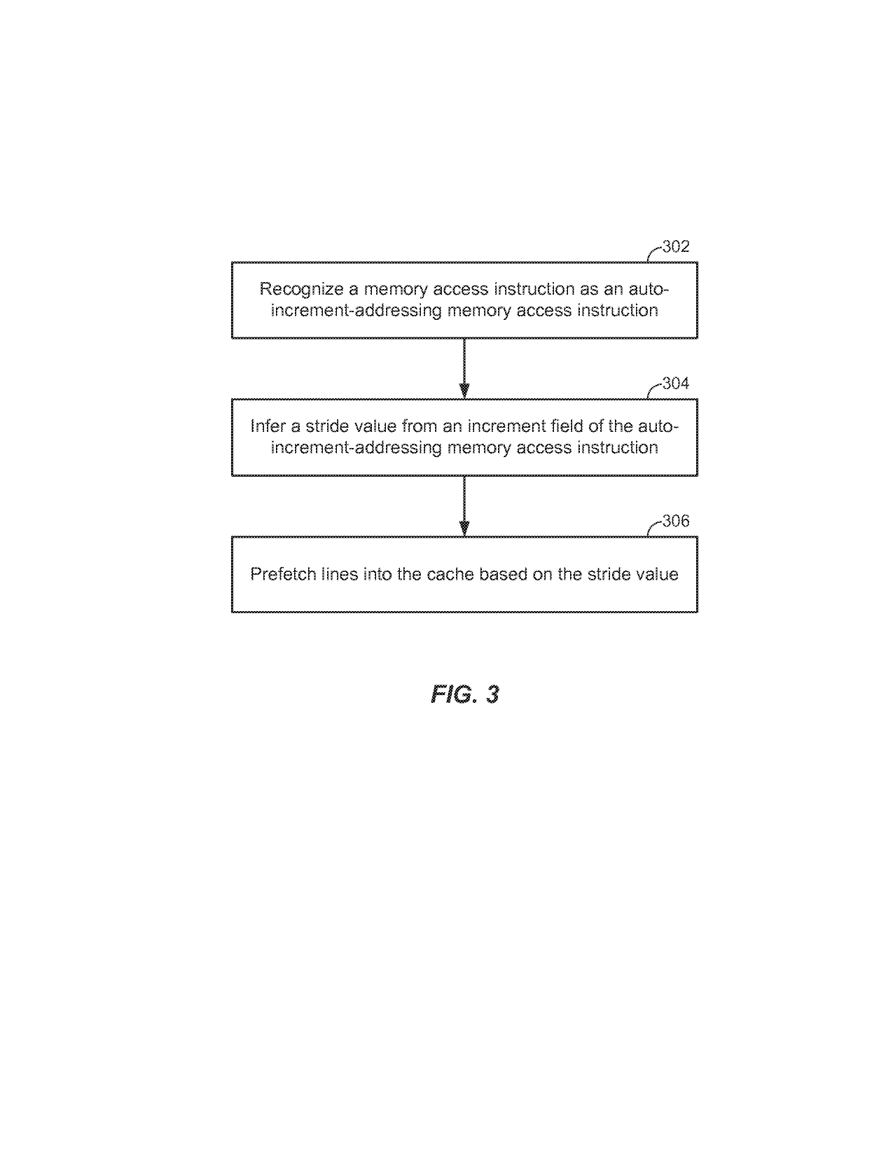

It will also be appreciated that as illustrated in FIG. 3, the embodiments including a specified auto-increment-address memory access instruction, may include a method of populating a cache (e.g. populating cache 104 by hardware prefetcher 106) comprising: recognizing a memory access instruction as an auto-increment-address memory access instruction (e.g. r2=load (r1++0x10))−Block 302; inferring a stride value from an increment field (e.g. 0x10) of the auto-increment-address memory access instruction—Block 304; and prefetching lines into the cache based on the stride value—Block 306.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

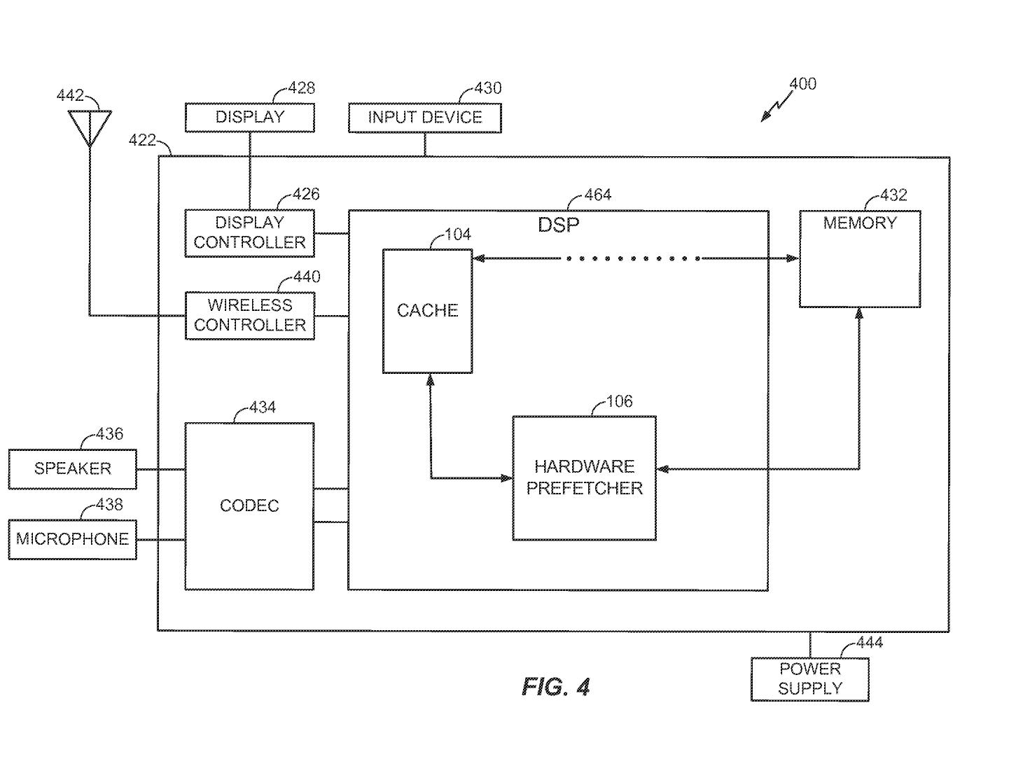

Referring to FIG. 4, a block diagram of a particular illustrative embodiment of a wireless device that includes a multi-core processor configured according to exemplary embodiments is depicted and generally designated 400. The device 500 includes a digital signal processor (DSP) 464, which may include cache 104 and hardware prefetcher 106 of FIG. 2 coupled to memory 532 as shown. FIG. 4 also shows display controller 426 that is coupled to DSP 464 and to display 428. Coder/decoder (CODEC) 434 (e.g., an audio and/or voice CODEC) can be coupled to DSP 464. Other components, such as wireless controller 440 (which may include a modem) are also illustrated. Speaker 436 and microphone 438 can be coupled to CODEC 434. FIG. 4 also indicates that wireless controller 440 can be coupled to wireless antenna 442. In a particular embodiment, DSP 464, display controller 426, memory 432, CODEC 434, and wireless controller 440 are included in a system-in-package or system-on-chip device 422.

In a particular embodiment, input device 430 and power supply 444 are coupled to the system-on-chip device 422. Moreover, in a particular embodiment, as illustrated in FIG. 4, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 depicts a wireless communications device, DSP 464 and memory 432 may also be integrated into a set-top box, a music player, a video player, an entertainment unit, a navigation device, a personal digital assistant (PDA), a fixed location data unit, or a computer. A processor (e.g., DSP 464) may also be integrated into such a device.

Accordingly, an embodiment of the invention can include a computer readable media embodying a method for populating a cache with prefetched information. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of populating a cache comprising:
recognizing a memory access instruction as an auto-increment-address memory access instruction;
inferring a stride value from an increment field of the auto-increment-address memory access instruction; and
prefetching lines into the cache based ort the stride value.

2. The method of claim 1, wherein the auto-increment—address memory access instruction is part of a hardware loop.

3. The method of claim 2, wherein a number of lines to prefetch is determined by a comparison based on a remaining loop count of the hardware loop and the stride value.

4. The method of claim 3, wherein the number of lines to prefetch is truncate when the remaining loop count is less than the number of lines to prefetch.

5. The method of claim 1, wherein the memory access instruction is a load instruction.

6. The method of claim 1, wherein the memory access instruction is a store instruction.

7. A method of populating a cache comprising:
initiating a prefetch operation;
recognizing that prefetched cache lines are part of a hardware loop;
determining a maximum loop count as a loop count specified in the hardware loop;
determining a remaining loop count as a difference between the maximum loop count and a number of loop iterations that have been completed;
selecting a number of cache lines to prefetch into the cache; and
truncating an actual number of cache lines to prefetch to be less than or equal to the remaining loop count, when the remaining loop count is less than the selected number of cache lines.

8. A hardware prefetcher comprising:
logic configured to receive instructions;
logic configured to recognize an instruction as an auto-increment-address memory access instruction;
logic configured to infer a stride value from an increment field of the auto-increment-address memory access instruction; and
logic configured to prefetch lines into a cache coupled to the hardware prefetcher based on the stride value.

9. The hardware prefetcher of claim 8 coupled to a memory, wherein the hardware prefetcher further comprises logic configured to prefetch lines into the cache from the memory, based on the stride value.

10. The hardware prefetcher of claim 8, wherein the auto-increment-address memory access instruction is part of a hardware loop.

11. The hardware prefetcher of claim 10, wherein a number of lines to prefetch is determined by a comparison based on a remaining loop count of a hardware loop and the stride value.

12. The hardware prefetcher of claim 11, wherein the number of lines to prefetch is truncated when the remaining loop count is less than the number of lines to prefetch.

13. The hardware prefetcher of claim 8, wherein to-increment-address memory access instruction is a load instruction.

14. The hardware prefetcher of claim 8, wherein the auto-increment-address memory access instruction is a store instruction.

15. The hardware prefetcher of claim 8 integrated in a semiconductor die.

16. The hardware prefetcher of claim 8, integrated into a device selected from the group consisting of a set top box, music player, video player, entertainment unit, navigation device, communications device, personal digital assistant (PDA), fixed location data unit, and a computer.

17. A hardware prefetcher for prefetching cache lines into a cache comprising:
logic configured to receive instructions;
logic configured to recognize that instructions received are part of a hardware loop;
logic configured to determine a maximum loop count as a loop count specified in the hardware loop;
logic configured to determine a remaining loop count as a difference between the maximum loop count and a number of loop iterations that have been completed;
logic configured to select a number of cache lines to prefetch into the cache; and
logic configured to truncate an actual number of cache lines to prefetch to be less than or equal to the remaining loop count, when the remaining loop count is less than the selected number of cache lines.

18. The hardware prefetcher of claim 17 integrated in a semiconductor die.

19. The hardware prefetcher of claim 17, integrated into a device selected from the group consisting of a set top box, music player, video player, entertainment unit, navigation device, communications device, personal digital assistant (PDA), fixed location data unit, and a computer.

20. A processing system comprising:
a cache;
a memory;
means for recognizing an instruction for accessing the memory as an auto-increment-address memory access instruction;
means for inferring a stride value from an increment field of the auto-increment-address memory access instruction; and
means for prefetching lines into the cache based on the stride value.

21. The processing system of claim 20, wherein the auto-increment-address memory access instruction is part of a hardware loop.

22. The processing system of claim 20, further comprising means for determining a number of lines to prefetch based on a comparison of a remaining loop count of the hardware loop and the stride value.

23. The processing system of claim 22, wherein the number of lines to prefetch is truncated when the remaining loop count is less than the number of lines to prefetch.

24. A processing system comprising:
a cache;
means for initiating a prefetch operation for prefetching cache lines into the acne;
means for recognizing that prefetched cache lines are part of a hardware loop;
means for determining a maximum loop count as a loop count specified in the hardware loop;
means for determining a remaining loop count as a difference between the maximum loop count and a number of loop iterations that have been completed;
means for selecting a number of cache lines to prefetch; and
means for truncating an actual number of cache lines to prefetch to be less than or equal to the remaining loop count, when the remaining loop count is less than the selected number of cache lines.

25. A non-transitory computer-readable storage medium comprising code, which, when executed by a processor, causes the processor to perform operations for prefetching cache lines from a memory into a cache coupled to the processor, the non-transitory computer-readable storage medium comprising:
code for recognizing an instruction for accessing the memory as an auto-increment dress memory access instruction;
code for inferring a stride value from an increment field of the auto-increment-address memory access instruction; and
code for prefetching lines into the cache based on the stride value.

26. A non-transitory computer-readable storage medium comprising code, which, when executed by a processor, causes the processor to perform operations for prefetching cache lines from a memory into a cache coupled to the processor, the non-transitory computer-readable storage medium comprising:
code for initiating a prefetch operation for prefetching cache lines into the cache;
code for recognizing that prefetched cache lines are part of a hardware loop;
code for determining a maximum loop count as a loop count specified it hardware loop;
code for determining a remaining loop count as a difference between the maximum loop count and a number of loop iterations that have been completed;
code for selecting a number of cache lines to prefetch; and
code for truncating an actual number of cache lines to prefetch to be less than or equal to the remaining loop count, when the remaining loop count is less than the selected number of cache lines.
